(19) United States
(12) Patent Application Publication
(10) Pub. No.: US 2019/0036644 A1
(43) Pub. Date: Jan. 31, 2019

(54) Systems and Methods for Reliable Communication for Short Transmission Time Interval in Long Term Evolution Through Repetitions

(71) Applicant: Telefonaktiebolaget LM Ericsson (publ), Stockholm (SE)

(72) Inventors: Gustav Wikström, Täby (SE); Niklas Andgart, Södra Sandby (SE); Malik Wahaj Arshad, Sigtuna, Stockholm (SE); Torsten Dudda, Aachen (DE); Zhenhua Zou, Solna (SE)

(21) Appl. No.: 15/752,649

(22) PCT Filed: Nov. 27, 2017
(86) PCT No.: PCT/SE2017/051172

§ 371 Date: Feb. 14, 2018

Related U.S. Application Data
(60) Provisional application No. 62/427,351, filed on Nov. 29, 2016.

(51) Int. Cl. H04L 1/00; H04W 72/12

(52) U.S. Cl. CPC H04L 1/0036; H04L 1/0046; H04W 72/1226

(57) ABSTRACT

According to certain embodiments, a method by a wireless device is provided for reliable communication for short transmission time interval (TTI) through repetitions. The method includes receiving, from a network node, a configuration comprising a short TTI transmission schedule identifying a repetition factor. Based on the short TTI transmission schedule and the repetition factor, the wireless device searches for a plurality of repeated messages from the network node and combines the plurality of repeated messages.

### TECHNICAL FIELD

The present disclosure relates, in general, to wireless communications and, more particularly, systems and methods for systems and methods for reliable communication for short transmission time interval in Long Term Evolution through repetitions.

### BACKGROUND

Packet data latency is one of the performance metrics that vendors, operators and also end-users (via speed test applications) regularly measure. Latency measurements are done in all phases of a radio access network system lifetime such as when verifying a new software release or system component, when deploying a system, and when the system is in commercial operation.

Shorter latency than previous generations of 3GPP RATs was one performance metric that guided the design of Long Term Evolution (LTE). LTE is also now recognized by the end-users to be a system that provides faster access to internet and lower data latencies than previous generations of mobile radio technologies.

Packet data latency is important not only for the perceived responsiveness of the system; it is also a parameter that indirectly influences the throughput of the system. HTTP/TCP is the dominating application and transport layer protocol suite used on the internet today. According to HTTP Archive (http://httparchive.org/trends.php), the typical size of HTTP based transactions over the internet are in the range of a few 10's of Kbyte up to 1 Mbyte. In this size range, the TCP slow start period is a significant part of the total transport period of the packet stream. During TCP slow start, the performance is latency limited. Hence, improved latency can rather easily be showed to improve the average throughput for this type of TCP based data transactions.

### SUMMARY

To address the foregoing problems with existing solutions, disclosed is systems and methods for providing reliable communication for short transmission time interval (TTI) in through repetitions.

According to certain embodiments, a method by a wireless device provides reliable communication for short TTI through repetitions. The method includes receiving, from a network node, a configuration including a short TTI transmission schedule identifying a repetition factor. Based on the short TTI transmission schedule and the repetition factor, the wireless device searches for a plurality of repeated messages from the network node and combines the plurality of repeated messages.

According to certain embodiments, a wireless device is provided for reliable communication for short TTI through repetitions. The wireless device includes memory storing instructions and processing circuitry configured to execute the instructions to cause the UE to receive, from a network node, a configuration including a short TTI transmission schedule identifying a repetition factor. Based on the short TTI transmission schedule and the repetition factor, a search is performed for a plurality of repeated messages from the network node. The plurality of repeated messages are combined.

According to certain embodiments, a method by a network node is provided for reliable communication for short TTI through repetitions. The method includes transmitting, to a wireless device, a configuration including a short TTI transmission schedule identifying a repetition factor. Based on the short TTI transmission schedule and the repetition factor, the network node transmits a plurality of repeated messages for combination by the UE.

According to certain embodiments, a network node is provided for reliable communication for short TTI through repetitions. The network node includes a memory storing instructions and processing circuitry configured to execute the instructions to cause the network node to transmit, to a wireless device, a configuration including a short TTI transmission schedule identifying a repetition factor. Based on the short TTI transmission schedule and the repetition factor, the network node transmits a plurality of repeated messages for combination by the wireless device.

According to certain embodiments, a method by a wireless device is provided for reliable communication for short transmission time interval (TTI) through repetitions. The method includes receiving, from a network node, a first configuration comprising a short TTI transmission schedule identifying a repetition factor. Based on the short TTI transmission schedule and the repetition factor, the network node transmits a first plurality of repeated messages for combination by the network node.

According to certain embodiments, a wireless device provides reliable communication for short transmission time interval (TTI) through repetitions. The wireless device includes memory storing instructions and processing circuitry configured to execute the instructions to cause the wireless device to receive, from a network node, a first configuration comprising a short TTI transmission schedule identifying a repetition factor. Based on the short TTI transmission schedule and the repetition factor, the wireless device transmits a first plurality of repeated messages for combination by the network node.

According to certain embodiments, a method by a network node provides for reliable communication for short TTI in LTE through repetitions. The method includes transmitting, to a wireless device, a first configuration comprising a short TTI transmission schedule identifying a repetition factor. Based on the short TTI transmission schedule and the repetition factor, the network node searches for a first plurality of repeated messages from the wireless device and combines the plurality of repeated messages.

According to certain embodiments, a network node provides reliable communication for short TTI through repetitions. The network node includes memory storing instructions and processing circuitry configured to execute the instructions to cause the network node to transmit, to a wireless device, a first configuration comprising a short TTI transmission schedule identifying a repetition factor. Based on the short TTI transmission schedule and the repetition factor, the network node searches for a first plurality of repeated messages from the UE and combines the plurality of repeated messages.

Certain embodiments of the present disclosure may provide one or more technical advantages. For example, certain embodiments may enable transmissions with very high reliability within a time span less than a subframe. Another advantage may be that the framework of short transmission time interval (TTI) can be reused and scheduling can therefore be done together with other short TTI users.

Other advantages may be readily apparent to one having skill in the art. Certain embodiments may have none, some, or all of the recited advantages.

### BRIEF DESCRIPTION OF THE DRAWINGS

For a more complete understanding of the disclosed embodiments and their features and advantages, reference is now made to the following description, taken in conjunction with the accompanying drawings, in which:

FIG. 1 illustrates a wireless communication network for providing reliable communication for short transmission time interval (TTI) through repetitions, according to certain embodiments;

FIG. 2 illustrates a method for reliable low latency communication, according to certain embodiments;

FIG. 3 illustrates a flow chart for reliable low latency communication signaling, according to certain embodiments;

FIG. 4 illustrates pipelined buffering and decoding of soft values in a wireless device, according to certain embodiments;

FIG. 5 illustrates an exemplary wireless device for providing reliable communication for short TTI through repetitions, according to certain embodiments;

FIG. 6 illustrates an exemplary method by a wireless device for providing reliable communication for short TTI through repetitions, according to certain embodiments;

FIG. 7 illustrates a virtual computing device for providing reliable communication for short TTI through repetitions, according to certain embodiments;

FIG. 8 illustrates another exemplary method by a wireless device for providing reliable communication for short TTI through repetitions, according to certain embodiments;

FIG. 9 illustrates another virtual computing device for providing reliable communication for short TTI through repetitions, according to certain embodiments;

FIG. 10 illustrate an example network node for providing reliable communication for short TTI through repetitions, according to certain embodiments;

FIG. 11 illustrates an exemplary method by a network node for providing reliable communication for short TTI through repetitions, according to certain embodiments;

FIG. 12 illustrates another virtual computing device for providing reliable communication for short TTI through repetitions, according to certain embodiments;

FIG. 13 illustrates another exemplary method by a network node for providing reliable communication for short TTI through repetitions, according to certain embodiments;

FIG. 14 illustrates another virtual computing device for providing reliable communication for short TTI through repetitions, according to certain embodiments; and

FIG. 15 illustrates an exemplary radio network controller or core network node, in accordance with certain embodiments.

### DETAILED DESCRIPTION

Radio resource efficiency could be positively impacted by latency reductions. Lower packet data latency may increase the number of transmissions possible within a certain delay bound. Thus, higher Block Error Rate (BLER) targets could be used for the data transmissions freeing up radio resources potentially improving the capacity of the system.

One area to address when it comes to packet latency reductions is the reduction of transport time of data and control signaling, by addressing the length of a transmission time interval (TTI). In LTE release 8, a TTI corresponds to one subframe (SF) of length 1 millisecond. One such 1 ms TTI is constructed by using 14 Orthogonal Frequency Division Multiple Access (OFDM) or Single Carrier-Frequency Division Multiple Access (SC-FDMA) symbols in the case of normal cyclic prefix and 12 OFDM or SC-FDMA symbols in the case of extended cyclic prefix. In LTE release 13, a study item started during 2015, with the goal of specifying transmissions with shorter TTIs that are much shorter than the LTE release 8 TTI.

The shorter TTIs may have any duration in time and comprise resources on a number of OFDM or SC-FDMA symbols within a 1 ms SF. As one example, the duration of the short TTI may be 0.5 ms, which may include seven OFDM or SC-FDMA symbols for the case with normal cyclic prefix. As another example, the duration of the short TTI may be 2 symbols.

With current control (Physical Downlink Control Channel (PDCCH) or short Physical Downlink Control Channel (sPDCCH)) the lowest achievable error probability is in the order of 0.1%. This means that an entire transmission of control+data will not have a reliability above this level. With higher layer solutions, such as Hybrid Automatic Repeat Request (HARQ) or Radio Link Control (RLC), retransmissions could be triggered in order to ensure a total combined reliability at the required level. However, such a procedure would be time consuming and could not be performed at the 1 ms level.

Particular embodiments of the present disclosure may provide solutions enabling reliable communication for short TTI through repetitions. Specifically, a new type of transmission for LTE is proposed with predefined automatic repetitions of control and data that may be blindly detected and combined in the receiver in order to improve reliability.

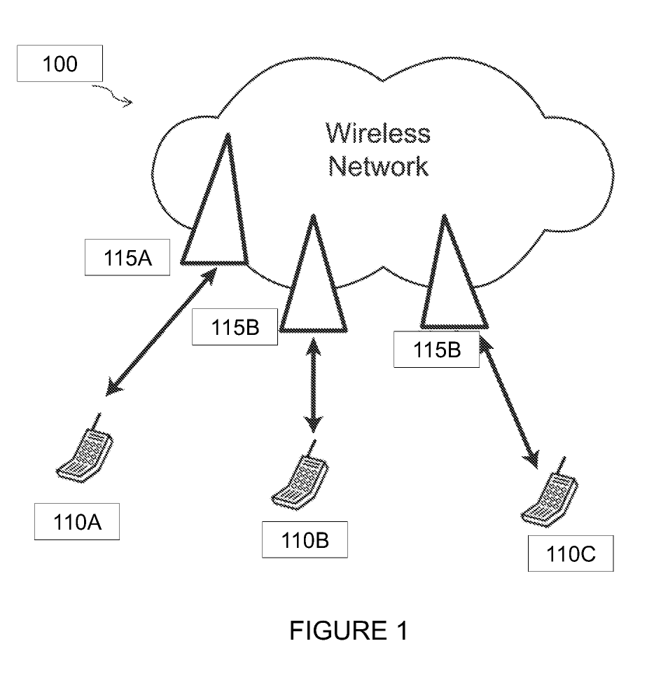

Certain embodiments may include functionality for providing reliable communication for short TTI through repetitions. Particular embodiments are described in FIGS. 1-15 of the drawings, like numerals being used for like and corresponding parts of the various drawings.

FIG. 1 is a block diagram illustrating an embodiment of a network 100 for providing reliable communication for short TTI through repetitions, according to certain embodiments. Network 100 includes one or more wireless devices 110A-C, which may be interchangeably referred to as wireless devices 110 or UEs 110, and network nodes 115A-C, which may be interchangeably referred to as network nodes 115 or eNodeBs 115. A wireless device 110 may communicate with network nodes 115 over a wireless interface. For example, wireless device 110A may transmit wireless signals to one or more of network nodes 115, and/or receive wireless signals from one or more of network nodes 115. The wireless signals may contain voice traffic, data traffic, control signals, and/or any other suitable information. In some embodiments, an area of wireless signal coverage associated with a network node 115 may be referred to as a cell. In some embodiments, wireless devices 110 may have D2D capability. Thus, wireless devices 110 may be able to receive signals from and/or transmit signals directly to another wireless device 110. For example, wireless device 110A may be able to receive signals from and/or transmit signals to wireless device 110B.

In certain embodiments, network nodes 115 may interface with a radio network controller (not depicted in FIG. 1). The radio network controller may control network nodes 115 and may provide certain radio resource management functions, mobility management functions, and/or other suitable functions. In certain embodiments, the functions of the radio network controller may be included in network node 115. The radio network controller may interface with a core network node. In certain embodiments, the radio network controller may interface with the core network node via an interconnecting network. The interconnecting network may refer to any interconnecting system capable of transmitting audio, video, signals, data, messages, or any combination of the preceding. The interconnecting network may include all or a portion of a public switched telephone network (PSTN), a public or private data network, a local area network (LAN), a metropolitan area network (MAN), a wide area network (WAN), a local, regional, or global communication or computer network such as the Internet, a wireline or wireless network, an enterprise intranet, or any other suitable communication link, including combinations thereof.

In some embodiments, the core network node may manage the establishment of communication sessions and various other functionalities for wireless devices 110. Wireless devices 110 may exchange certain signals with the core network node using the non-access stratum layer. In non-access stratum signaling, signals between wireless devices 110 and the core network node may be transparently passed through the radio access network. In certain embodiments, network nodes 115 may interface with one or more network nodes over an internode interface. For example, network nodes 115A and 115B may interface over an X2 interface.

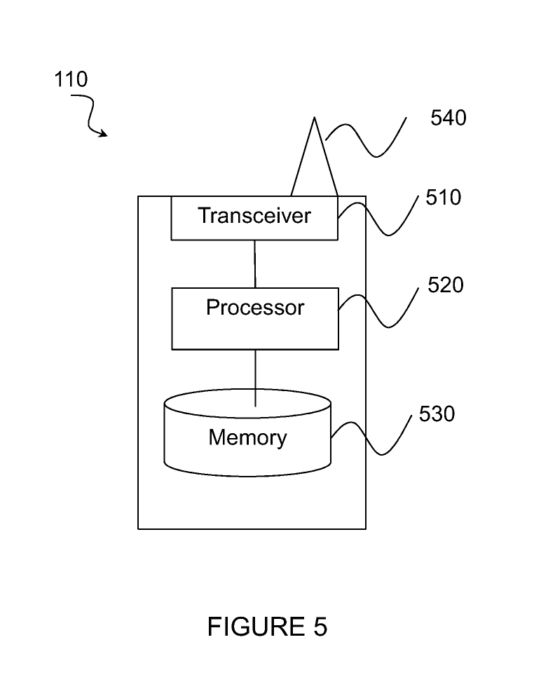

As described above, example embodiments of network 100 may include one or more wireless devices 110, and one or more different types of network nodes capable of communicating (directly or indirectly) with wireless devices 110. Wireless device 110 may refer to any type of wireless device communicating with a node and/or with another wireless device in a cellular or mobile communication system. Examples of wireless device 110 include a mobile phone, a smart phone, a PDA (Personal Digital Assistant), a portable computer (e.g., laptop, tablet), a sensor, a modem, a machine-type-communication (MTC) device/machine-to-machine (M2M) device, laptop embedded equipment (LEE), laptop mounted equipment (LME), USB dongles, a D2D capable device, or another device that can provide wireless communication. A wireless device 110 may also be referred to as UE, a station (STA), a device, or a terminal in some embodiments. Also, in some embodiments, generic terminology, “radio network node” (or simply “network node”) is used. It can be any kind of network node, which may comprise a Node B, base station (BS), multi-standard radio (MSR) radio node such as MSR BS, eNode B, network controller, radio network controller (RNC), base station controller (BSC), relay donor node controlling relay, base transceiver station (BTS), access point (AP), transmission points, transmission nodes, RRU, RRH, nodes in distributed antenna system (DAS), core network node (e.g. MSC, MME etc.), O&M, OSS, SON, positioning node (e.g. E-SMLC), MDT, or any suitable network node. Example embodiments of network nodes 115, wireless devices 110, and other network nodes (such as radio network controller or core network node) are described in more detail with respect to FIGS. 5, 10, and 15.

Although FIG. 1 illustrates a particular arrangement of network 100, the present disclosure contemplates that the various embodiments described herein may be applied to a variety of networks having any suitable configuration. For example, network 100 may include any suitable number of wireless devices 110 and network nodes 115, as well as any additional elements suitable to support communication between wireless devices or between a wireless device and another communication device (such as a landline telephone). Furthermore, although certain embodiments may be described as implemented in a long term evolution (LTE) network, the embodiments may be implemented in any appropriate type of telecommunication system supporting any suitable communication standards and using any suitable components, and are applicable to any radio access technology (RAT) or multi-RAT systems in which the wireless device receives and/or transmits signals (e.g., data). For example, the various embodiments described herein may be applicable to LTE, LTE-Advanced, LTE-U UMTS, HSPA, GSM, cdma2000, WiMax, WiFi, another suitable radio access technology, or any suitable combination of one or more radio access technologies. Although certain embodiments may be described in the context of wireless transmissions in the downlink, the present disclosure contemplates that the various embodiments are equally applicable in the uplink and vice versa.

The techniques described herein are applicable to both LAA LTE and standalone LTE operation in license-exempt channels. The described techniques are generally applicable for transmissions from both network nodes 115 and wireless devices 110.

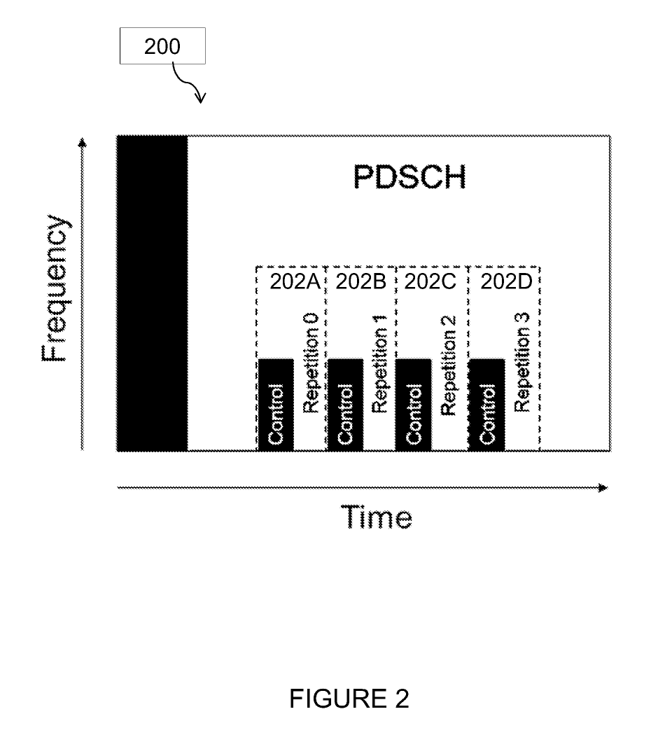

FIG. 2 illustrates a method 200 for reliable low latency communication, according to certain embodiments. The transmission method follows the TTI pattern as defined for short TTI operation. Thus, FIG. 2 depicts example repetitions 202A-D of short TTI. Additionally, the transmission method is defined with a control search space in a Radio Resource Control (RRC) message and is defined for uplink (UL) and downlink (DL). In certain embodiments, the receiver, which may be a wireless device 110, is configured with the search space and will continuously search for control messages in this search space.

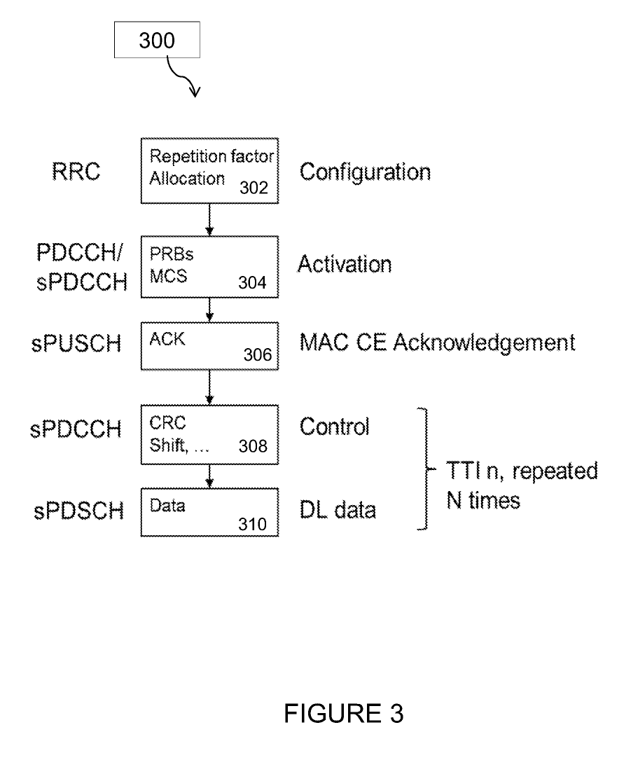

FIG. 3 illustrates a flow chart 300 for reliable low latency communication signaling, according to certain embodiments. In certain embodiments, the short TTI transmission scheduled with sPDCCH can be replaced with 1 ms transmissions scheduled with PDCCH. The combining of data and control would then be at a 1 ms level instead of a sub-1 ms level.

In certain embodiments, the data allocation 302 may be defined through a SPS grant, where a SPS pattern is defined with RRC and an SPS activation message 304 is sent on PDCCH or sPDCCH. The SPS activation message 304 should be acknowledged 306 by wireless device 110 with a data message over PUCCH or sPUCCH. In a particular embodiment, the data allocation 302 is predefined with a RRC message to wireless device 110. For example, in a particular embodiment, a repetition factor N is defined for wireless device 110 and signaled to wireless device 110 in a RRC message. In another particular embodiment, the repetition factor may be included in the SPS activation message 304. In still another particular embodiment, the repetition factor included in the RRC message at 302 or SPS activation message 304 may be described as a list of indices or bitmap of short TTIs within a subframe or an SPS period.

In certain embodiments, the transmitter, which may be a part of the wireless device 110, the network node 115, or other network node, may transmit N identical repetitions of the control (DL) and data packet in adjacent short TTIs at 308-310. The transmissions may be allowed to start in any short TTI.

For example, in a particular embodiment, a hopping pattern may be applied to the transmissions such that, for example, the first repetition (rep. 0) is on PRB 1-10, the second is on 11-20, and so on. The repetitions may follow the same known pattern in time such as, for example, a number of consecutive TTIs. The objective of the hopping pattern is to improve frequency diversity. If the first transmission is placed on some frequency resources (for example PRB 1-10), and in the next TTI, the repeated transmission is placed on other resources (for example PRB 11-20), then the channel characteristics may be different in the different parts of the channel. If the channel has a fading dip in the frequency region where the first transmission was sent, but is better in the frequency region where the second transmission is sent, the decoding will typically succeed.

In another example embodiment, however, the repetitions may be more seldom in time. For example, instead of having repetitions on consecutive sTTIs, which may have similar channel characteristics due to low UE speed (low Doppler), the repetitions may be spread out with longer time intervals between them. Doing so may improve performance since the channel has probably changed more between the repetitions, and there is higher time diversity in the repetitions. As long as the repetition pattern in time is known, the technique will work. These spread-out repetitions in time will, however, mean that the latency in the transmission gets longer, as it takes longer time until the message can finally be decoded. It may also require more memory in the receiver, as soft values related to one transmission will be need to be stored for longer periods.

In certain embodiments, as the channel conditions change, the repetition factor may be increased or decreased. For example, in a best case scenario, resources may be potentially saved by reducing repetition factor N. Also, the initial allocated repetition maybe too conservative. In such a case, the number may be increased to just meet the reliability factor based on changing channel conditions.

Another impacting factor may be network congestion. Considering a generous selection of repetition factor by network, the repetition factor should be adaptively reduced while meeting the reliability conditions for URLLC in case network congestion starts to increase. For example, in a particular embodiment, the repetition factor is adapted based on channel conditions and network congestion situation using RRC or SPS activation.

In certain embodiments and considering the fact that the LTE standard allows the terminal to transmit the CSI with 10% BLER, a generous allocation of the repetition factor may be performed in the start to meet the high reliability requirements. This may be later adapted when stable and consistent reports are received from the terminal. For example, the network should be generous in repetition factor allocation in the start to cater the BLER in CSI, in particular embodiments.

Certain embodiments may provide downlink control. Specifically, according to certain embodiments, the search space may for instance be defined with a physical resource block (PRB) range, as PRB 1-20, 21-40, and 1-40. Overlapping search spaces may be defined for multiple wireless devices 110. In a particular embodiment, the search space should be consistent over subframes. For example, in a particular embodiment, the search space is modified by the number of PDCCH symbols in a subframe, which may be indicated for the subsequent subframe in the new control.

Beside the search space in the frequency domain, in a particular embodiment, it may be further indicated which short TTI within a subframe refer to the short TTI containing scheduling information. This indication may be done by providing an index or a list of indices or a bitmap of the respective short TTIs containing scheduling information. Furthermore, the information may include which short TTIs are used for data transmission or repetitive data transmissions (if the control short TTI is received).

In a particular embodiment, wireless device 110 searches for a control short TTI according to search space/short TTI information above, and applies descrambling with a certain identity e.g. certain C-RNTI. The short TTI control is scrambled (or at least parts of it, e.g. CRC) is scrambled with this UE identity by the network node 115. If decoding/CRC check is successful, the control information is considered, otherwise not. The wireless device 110 may in this case (or generally, if configured) try decoding the short TTI regularly, e.g. based on included sDCI, i.e. SPDCCH and SPDSCH. This way, it is possible for the eNB to dynamically schedule control short TTIs to the UE or regular short TTIs, depending on current needs for high reliability.

In order to keep the payload of the new control as low as possible, and thereby the code rate and error rate as low as possible, some of the parameters of the data may be implicitly derived, in certain embodiments. The new control may consist of BPSK or QPSK symbols transmitted within a short TTI. The message encoded may contain information fields and an added CRC, as:
The Modulation and Coding Scheme (MCS) index
A shift indicator for the data PRB allocation
A bit indicator for a frequency hopping pattern of the data
The number of PDCCH symbols in next subframe, or equivalent time shift indicator.
   The number of PDCCH symbols or equivalent time shift indicator may be used by wireless device 110 to skip decoding the PDCCH region as data.

An example of the information fields encoded in the new control is given in Table 1 below:

| Information field | Size (bits) |
|---|---|
| MCS (optional) | 2 |
| Shift for data location (optional) | 3 |
| CRC | 16 |
| Total size | 16-21 |

In a particular embodiment, if the new control is used to schedule UL transmissions it may also include power control commands.

According to certain embodiments, wireless device 110 may search for downlink control in the preconfigured search space, and combine the receptions according to the repetition factor. As just one example, if the repetition factor is 3 and there are 6 short TTI (labeled short TTI 0-5) with a search space consisting of one control candidate in each, wireless device 110 may attempt to add the soft values of control combinations from short TTI:

0-1-2
1-2-3
2-3-4
3-4-5
4-5-0
5-0-1

This process may continue until the CRC for the wireless device's used C-RNTI, which may be a specific C-RNTI for this purpose, checks, in certain embodiments.

The advantage of this scheme may be that network node 115 is able to start transmitting newly arrived data at every short TTI and may not need to wait with the transmission until the next repetition bundle ends. For example, if data arrives at 0, it can be transmitted repetitively in 1-2-3, in the case no data had been transmitted in 0-1-2. Not applying this embodiment would mean: network node 115 sends nothing in 0-1-2, next transmission is in bundle 3-4-5, which includes a waiting time and thus an additional unwanted delay.

In a particular embodiment, the decoding may continue for remaining possible control candidates in the combination. Here, soft values from the successful receptions can be used as primer. Finding all the repetitions of the control is important for selecting the candidates for data.

According to a particular embodiment corresponding to the example above with repetition factor 3 and 6 short TTI, the received soft values in the current short TTI n may potentially represent three different candidates of transmission.

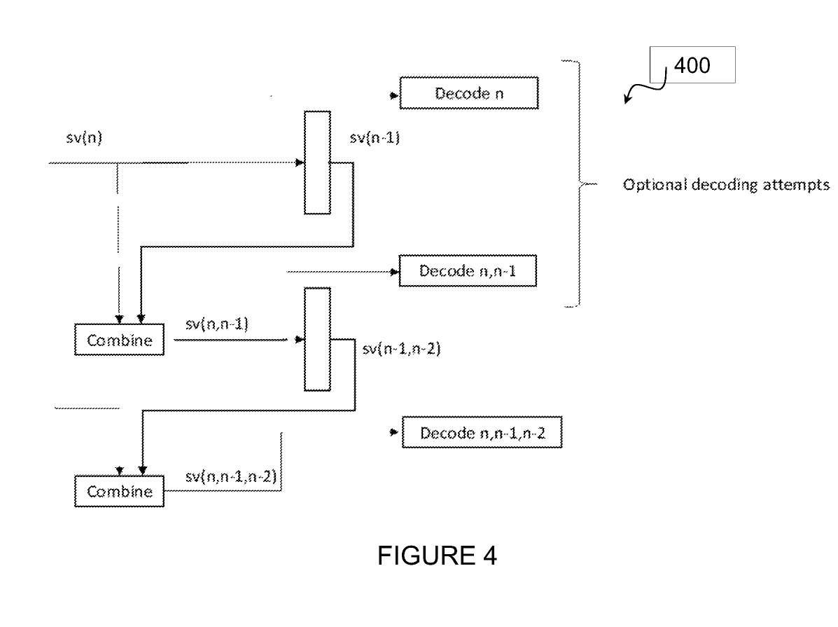

FIG. 4 illustrates pipelined buffering and decoding 400 of soft values in a wireless device 110, according to certain embodiments. As illustrated, wireless device 110 receives demodulated soft values, and decodes them, after combining soft value from different short TTIs. Wireless device 110 may then try to decode only soft values from short TTI n, from short TTI n and n−1, or from short TTI n, n−1 and n−2. This means that wireless device 110 potentially needs to do three decoding attempts per short TTI. In order to limit this, one or more of the decoding candidates may be excluded. If the high reliability is to be maintained, the final decoding attempt should be carried out, but in the cases where as fast decoding as possible is not needed, such as where the decoding attempt of only short TTI n may be excluded, wireless device processing may be reduced. This choice of which decoding attempts that should be carried out could be standardized, signaled from network node 115, be dependent on a wireless device capability, or be implementation-specific in wireless device 110, dependent on how much resources wireless device 110 wants to use for early decoding, according to various embodiments.

For example, in a particular embodiment, the search space consists of multiple candidates in each short TTI. Network node 115 may use the candidates according to a predetermined pattern signaled in RRC. Wireless device 110 may use the detected candidate index to find the sequence index of the repetitions. As an example, consider a repetition factor N=3 and a search space with 3 candidates. Network node 115 may configure the use of candidates to be 0-1-2, so that the first candidate is used in the first transmission in the sequence, etc. Wireless device 110 may then infer the sequence number from a control message that checks, and from the repetition factor know which short TTI data transmissions to combine.

In uplink, there is no control message, but wireless device 110 transmits according to the instructed repetition pattern, and network node 115 blindly detects the transmission and combines the received repetitions. In one embodiment, the instructed repetition pattern is configured by RRC or SPS activation as list or bitmap of short TTIs within a subframe or SPS period. The potential starting points to transmit a repetition bundle may be static, e.g. either 0-1-2 or 3-4-5. Alternatively, wireless device 110 may be instructed to start the repetition bundle dynamically at any of instructed short TTI eligible for repetitions. For example, wireless device 110 may be instructed to start and transmit at either 0-1-2, 1-2-3, 2-3-4 etc. Wireless device 110 may thereby observe that while a repetition bundle is ongoing, no further repetition bundle is started.

Certain embodiments may allow data combination. For example, in certain embodiments, once the control message/messages have been checked, wireless device 110 may attempt decoding of the predefined data region. Here, wireless device 110 may combine the data according to the short TTI pattern matching with the successful control message decoding. That is, in the example above, if a control message was decoded from short TTI 2 only, there are three matching data combinations:

0-1-2
1-2-3
2-3-4

However, wireless device 110 may not be certain about the short TTI from where soft values were not used. Therefore, the soft values for data may be combined for the short TTI where soft values for control were used. If one or more short TTI with unused soft values is surrounded by short TTIs with used soft values, the first short TTI's soft values can be used anyway. As an example, if 0 and 2 were used, also 1 can be used.

In certain embodiments, the transmitter may make sure that all repetitions are used, and are not interrupted for a new transmission.

In certain embodiments, HARQ feedback for each individual transmission may not be triggered. For example, in a particular embodiment, the receiver transmits a HARQ message once it has decoded a message, but otherwise nothing is transmitted.

Certain embodiments may include soft combining. Instead of a duplication of the data to be transmitted, it may be beneficial to transmit the repeated data in the short TTI using different redundancy versions (RV). The receiver benefits from this since the receiver can apply soft combining with a decoding gain. In a particular embodiment, for example, it is instructed for UL or DL transmission in RRC or SPS activation, which short TTI of the repetition applies which redundancy version within a subframe or within an SPS period. For example: each of the 6 short TTIs within one subframe may be configured to be used for repetitions with redundancy versions e.g. 0, 1, 2, 3, 0, 1, i.e. one redundancy version is configured per short TTI within a subframe.

According to certain embodiments, the methods described above may be performed where wireless device 110 is the receiver of the repetitions of data. In other embodiments, wireless device 110 may be the transmitter of the repetitions of data. FIG. 5 illustrates an example wireless device 110 for providing reliable communication for short TTI through repetitions, in accordance with certain embodiments.

As depicted, wireless device 110 includes transceiver 510, processor 520, and memory 530. In some embodiments, transceiver 510 facilitates transmitting wireless signals to and receiving wireless signals from network node 115 (e.g., via an antenna 540), processor 520 executes instructions to provide some or all of the functionality described above as being provided by wireless device 110, and memory 530 stores the instructions executed by processor 520. Examples of a wireless device 110 are provided above.

Processor 520 may include any suitable combination of hardware and software implemented in one or more modules to execute instructions and manipulate data to perform some or all of the described functions of wireless device 110. In some embodiments, processor 520 may include, for example, one or more computers, one or more central processing units (CPUs), one or more microprocessors, one or more applications, processing circuitry, and/or other logic.

Memory 530 is generally operable to store instructions, such as a computer program, software, an application including one or more of logic, rules, algorithms, code, tables, etc. and/or other instructions capable of being executed by a processor. Examples of memory 330 include computer memory (for example, Random Access Memory (RAM) or Read Only Memory (ROM)), mass storage media (for example, a hard disk), removable storage media (for example, a Compact Disk (CD) or a Digital Video Disk (DVD)), and/or or any other volatile or non-volatile, non-transitory computer-readable and/or computer-executable memory devices that store information.

Other embodiments of wireless device 110 may include additional or separate components beyond those shown in FIG. 5 that may be responsible for providing certain aspects of the wireless device's functionality, including any of the functionality described above and/or any additional functionality (including any functionality necessary to support the solution described above). For example, some embodiments may include a field-programmable gate array or other hardware to implement wireless device functionality described herein.

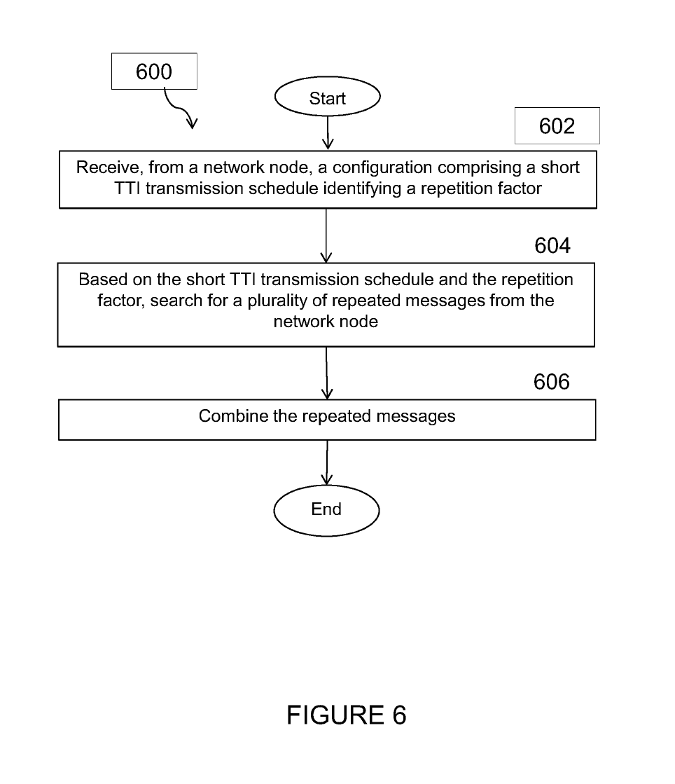

FIG. 6 illustrates an example method 600 by a wireless device 110 for providing reliable communication for short TTI through repetitions, according to certain embodiments. The method begins at step 602 when wireless device 110 receives, from a network node 112, a configuration comprising a short TTI transmission schedule identifying a repetition factor. According to certain embodiments, the repetition factor represents a number of repeated messages to be received from the network node. In a particular embodiment, the short TTI transmission schedule replaces a sub-1 ms transmission schedule with a 1 ms transmission schedule. In certain embodiments, the configuration may be received in a RRC message or SPS activation message.

At step 604, wireless device 110 searches for a plurality of repeated messages from network node 115 based on the short TTI transmission schedule and the repetition factor. According to certain embodiments, the plurality of repeated messages may include control information, data, or a combination of control information and data. In a particular embodiment, for example, the repeated messages comprise control messages, which may include power control commands.

According to certain embodiments, wireless device 110 may search for the plurality of repeated in a search space. In a particular embodiment, the search space may be identified by the short TTI transmission schedule. In another particular embodiment, the configuration may identify the search space as one or more ranges of physical resource blocks. In another embodiment, the configuration may include an index or list of indices or a bitmap of one or more short TTIs or candidates in each short TTI containing scheduling information. Wireless device 110 may then use the index to find the plurality of repeated messages.

According to certain embodiments, the repeated messages may be received in adjacent short TTIs. The repeated messages may comprise identical repetitions of control and/or data packets. Alternatively, the repeated messages may comprise a plurality of different redundancy versions.

At step 606, the repeated messages are combined. In certain embodiments, combining the messages may include selecting candidates for data after all repetitions of the repeated messages are identified. The combined repeated messages may then be decoded.

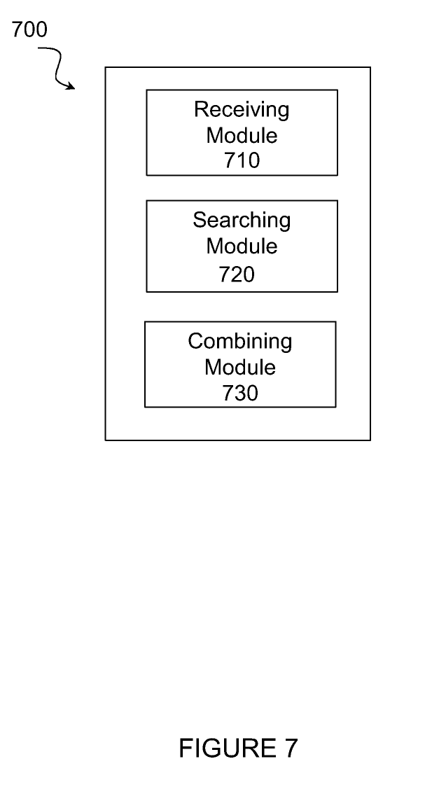

In certain embodiments, the method for providing reliable communication for short TTI through repetitions as described above may be performed by a virtual computing device. FIG. 7 illustrates an example virtual computing device 700 for providing reliable communication for short TTI through repetitions, according to certain embodiments. In certain embodiments, virtual computing device 700 may include modules for performing steps similar to those described above with regard to the method illustrated and described in FIG. 6. For example, virtual computing device 700 may include at least one receiving module 710, a searching module 720, a combining module 730, and any other suitable modules for providing reliable communication for short TTI through repetitions. In some embodiments, one or more of the modules may be implemented using one or more processors such as processor 720 discussed with regard to FIG. 5. In certain embodiments, the functions of two or more of the various modules may be combined into a single module.

The receiving module 710 may perform the receiving functions of virtual computing device 700. For example, in a particular embodiment, receiving module 710 may receive a configuration comprising a short TTI transmission schedule identifying a repetition factor.

The searching module 720 may perform the searching functions of virtual computing device 700. For example, in a particular embodiment, searching module 720 may search for a plurality of repeated messages from the second node based on the short TTI transmission schedule and the repetition factor.

The combining module 730 may perform the combining functions of virtual computing device 700. For example, in a particular embodiment, combining module 730 may combine the repeated messages.

Other embodiments of virtual computing device 700 may include additional components beyond those shown in FIG. 7 that may be responsible for providing certain aspects of the wireless device's functionality, including any of the functionality described above and/or any additional functionality (including any functionality necessary to support the solutions described above). The various different types of wireless devices may include components having the same physical hardware but configured (e.g., via programming) to support different radio access technologies, or may represent partly or entirely different physical components.

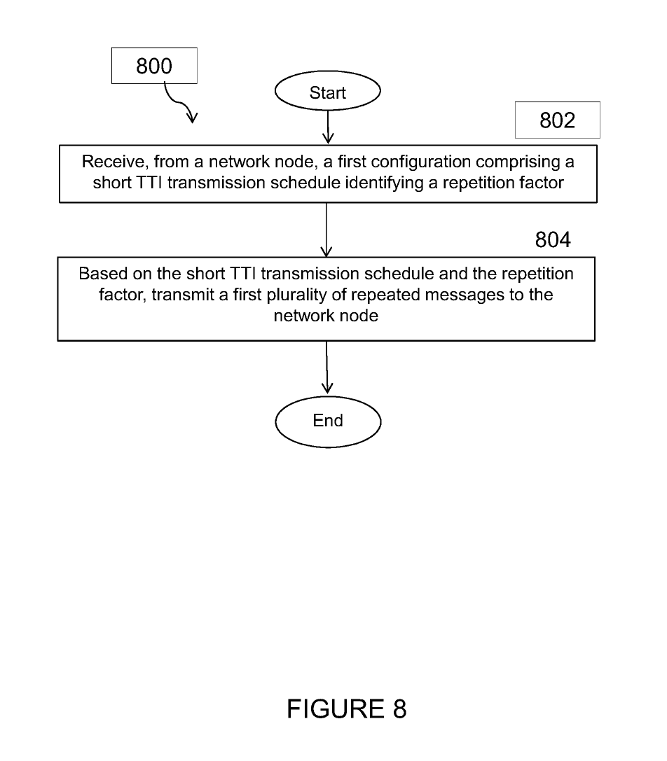

FIG. 8 illustrates an example method 800 by a wireless device 110 for providing reliable communication for short TTI through repetitions, according to certain embodiments. The method begins at step 802 when wireless device 110 receives, from a network node 112, a first configuration comprising a short TTI transmission schedule identifying a repetition factor. According to certain embodiments, the repetition factor represents a number of repeated messages to be transmitted to the network node. In a particular embodiment, the short TTI transmission schedule replaces a sub-1 ms transmission schedule with a 1 ms transmission schedule. In certain embodiments, the configuration may be received in a RRC message or SPS activation message.

At step 804, wireless device 110 transmits a first plurality of repeated messages to network node 115 based on the short TTI transmission schedule and the repetition factor. According to certain embodiments, the first plurality of repeated messages may include control information, data, or a combination of control information and data. In a particular embodiment, for example, the repeated messages comprise control messages, which may include power control commands.

According to certain embodiments, the first configuration may include an index or list of indices or a bitmap of one or more short TTIs containing scheduling information, and wireless device 110 may use the index, indices, or bitmap to transmit the repeated messages in one or more of the short TTIs. In another embodiment, the short TTI transmission schedule may include at least one range of physical resource blocks, and wireless device 110 may transmit the repeated messages in the identified physical resource blocks.

In a particular embodiment, the repeated messages may be transmitted in adjacent short TTIs. The repeated messages may comprise identical repetitions of control and/or data packets. Alternatively, the repeated messages may comprise a plurality of different redundancy versions.

In a particular embodiment, the method may further include receiving a second configuration modifying the repetition factor. Thereafter, wireless device 110 may transmit a second plurality of repeated messages based on the modified repetition factor.

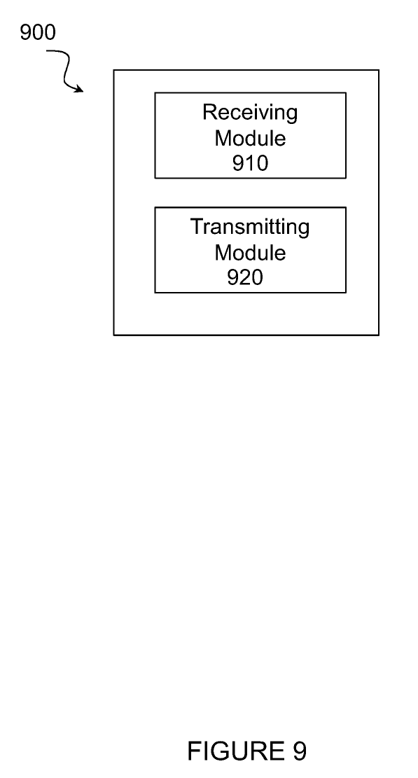

In certain embodiments, the method for providing reliable communication for short TTI through repetitions as described above may be performed by a virtual computing device. FIG. 9 illustrates an example virtual computing device 900 for providing reliable communication for short TTI through repetitions, according to certain embodiments. In certain embodiments, virtual computing device 900 may include modules for performing steps similar to those described above with regard to the method illustrated and described in FIG. 8. For example, virtual computing device 900 may include at least one receiving module 910, a transmitting module 920, and any other suitable modules for providing reliable communication for short TTI through repetitions. In some embodiments, one or more of the modules may be implemented using one or more processors such as processor 720 discussed with regard to FIG. 5. In certain embodiments, the functions of two or more of the various modules may be combined into a single module.

The receiving module 910 may perform the receiving functions of virtual computing device 900. For example, in a particular embodiment, receiving module 910 may receive a configuration comprising a short TTI transmission schedule identifying a repetition factor.

The transmitting module 920 may perform the transmitting functions of virtual computing device 900. For example, in a particular embodiment, transmitting module 920 may transmit a first plurality of repeated messages to network node 115 based on the short TTI transmission schedule and the repetition factor.

Other embodiments of virtual computing device 900 may include additional components beyond those shown in FIG. 9 that may be responsible for providing certain aspects of the wireless device's functionality, including any of the functionality described above and/or any additional functionality (including any functionality necessary to support the solutions described above). The various different types of wireless devices may include components having the same physical hardware but configured (e.g., via programming) to support different radio access technologies, or may represent partly or entirely different physical components.

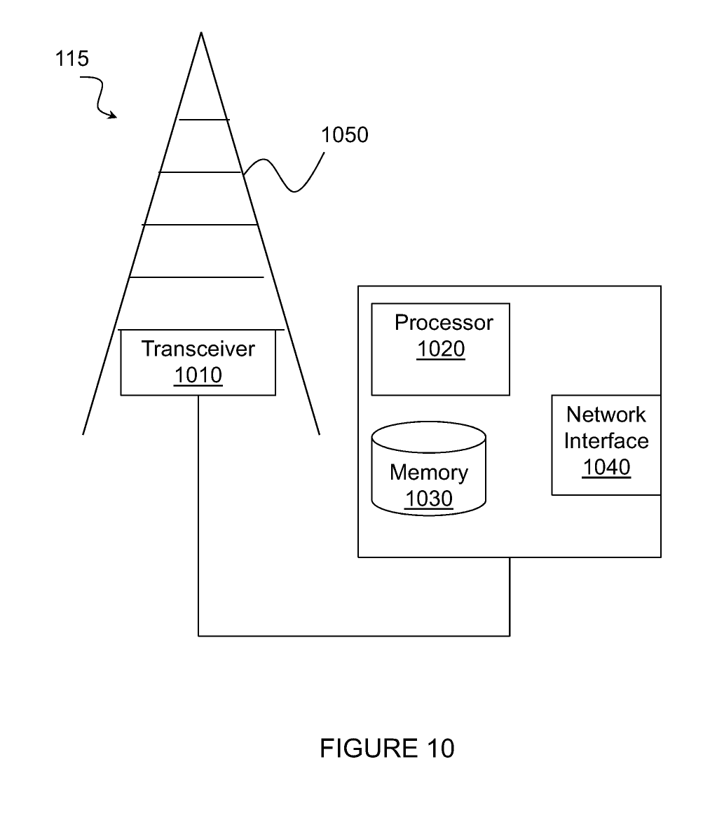

According to certain embodiments, the methods described above may be performed when network node 115 is the transmitter of the repetitions. In other embodiments, network node 115 may be the receiver of the repetitions. FIG. 10 illustrate an example network node 115 for providing reliable communication for short TTI through repetitions, according to certain embodiments. As described above, network node 115 may be any type of radio network node or any network node that communicates with a wireless device and/or with another network node. Examples of a network node 115 are provided above.

Network nodes 115 may be deployed throughout network 100 as a homogenous deployment, heterogeneous deployment, or mixed deployment. A homogeneous deployment may generally describe a deployment made up of the same (or similar) type of network nodes 115 and/or similar coverage and cell sizes and inter-site distances. A heterogeneous deployment may generally describe deployments using a variety of types of network nodes 115 having different cell sizes, transmit powers, capacities, and inter-site distances. For example, a heterogeneous deployment may include a plurality of low-power nodes placed throughout a macro-cell layout. Mixed deployments may include a mix of homogenous portions and heterogeneous portions.

Network node 115 may include one or more of transceiver 1010, processor 1020, memory 1030, network interface 1040, and antenna 1050. In some embodiments, transceiver 1010 facilitates transmitting wireless signals to and receiving wireless signals from wireless device 110 (e.g., via an antenna), processor 1020 executes instructions to provide some or all of the functionality described above as being provided by a network node 115, memory 1030 stores the instructions executed by processor 1020, and network interface 1040 communicates signals to backend network components, such as a gateway, switch, router, Internet, Public Switched Telephone Network (PSTN), core network nodes or radio network controllers, etc.

In certain embodiments, network node 115 may be capable of using multi-antenna techniques, and may be equipped with multiple antennas and capable of supporting MIMO techniques. The one or more antennas may have controllable polarization. In other words, each element may have two co-located sub elements with different polarizations (e.g., 90 degree separation as in cross-polarization), so that different sets of beamforming weights will give the emitted wave different polarization.

Processor 1020 may include any suitable combination of hardware and software implemented in one or more modules to execute instructions and manipulate data to perform some or all of the described functions of network node 115. In some embodiments, processor 1020 may include, for example, one or more computers, one or more central processing units (CPUs), one or more microprocessors, one or more applications, processing circuitry, and/or other logic.

Memory 1030 is generally operable to store instructions, such as a computer program, software, an application including one or more of logic, rules, algorithms, code, tables, etc. and/or other instructions capable of being executed by a processor. Examples of memory 1030 include computer memory (for example, Random Access Memory (RAM) or Read Only Memory (ROM)), mass storage media (for example, a hard disk), removable storage media (for example, a Compact Disk (CD) or a Digital Video Disk (DVD)), and/or or any other volatile or non-volatile, non-transitory computer-readable and/or computer-executable memory devices that store information.

In some embodiments, network interface 1040 is communicatively coupled to processor 1020 and may refer to any suitable device operable to receive input for network node 115, send output from network node 115, perform suitable processing of the input or output or both, communicate to other devices, or any combination of the preceding. Network interface 1040 may include appropriate hardware (e.g., port, modem, network interface card, etc.) and software, including protocol conversion and data processing capabilities, to communicate through a network.

Other embodiments of network node 115 may include additional or separate components beyond those shown in FIG. 10 that may be responsible for providing certain aspects of the radio network node's functionality, including any of the functionality described above and/or any additional functionality (including any functionality necessary to support the solutions described above). For example, some embodiments may include a field-programmable gate array or other hardware to implement network node functionality described herein. The various different types of network nodes may include components having the same physical hardware but configured (e.g., via programming) to support different radio access technologies, or may represent partly or entirely different physical components. Additionally, the terms first and second are provided for example purposes only and may be interchanged.

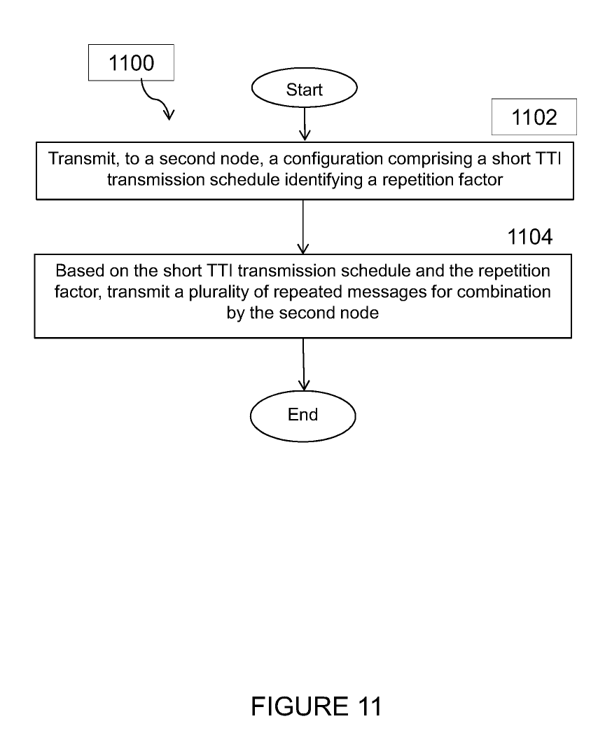

FIG. 11 illustrates an example method 1100 by a network node 110 for providing reliable communication for short TTI through repetitions, according to certain embodiments. The method begins at step 1102 when network node 115 transmits, to a wireless device 110, a configuration comprising a short TTI transmission schedule identifying a repetition factor. According to certain embodiments, the repetition factor represents a number of repeated messages to be received from the network node. In a particular embodiment, the short TTI transmission schedule replaces a sub-1 ms transmission schedule with a 1 ms transmission schedule. In certain embodiments, the configuration may be received in a RRC message or SPS activation message.

In certain embodiments, the configuration identifies a search space. In a particular embodiment, for example, the search space may include one or more ranges of physical resource blocks in which wireless device 110 may search for repeated messages. In another embodiment, the search space may include a plurality of candidates in each short TTI. In certain embodiments, the configuration may include an index or list of indices or a bitmap of one or more short TTIs containing scheduling information that wireless device 110 may use when searching for repeated messages. In certain embodiments, the repetition factor represents a number of repeated messages to be transmitted from the network node.

At step 1104, network node 115 transmits a plurality of repeated messages based on the short TTI transmission schedule and the repetition factor. The repeated messages are transmitted for combining by wireless device 110. According to certain embodiments, the repeated messages may include control information, data, or a combination thereof. In certain embodiments, the repeated messages comprise control messages, which may include power control commands, in particular embodiments.

In a particular embodiment, the repeated messages may be transmitted in adjacent short TTIs. The repeated messages may comprise identical repetitions of control and/or data packets. Alternatively, the repeated messages may comprise a plurality of different redundancy versions.

Though not explicitly depicted, in a particular embodiment, network node 115 may determine that the repetition factor should be modified and transmit a new repetition factor to wireless device 110. For example, network node 115 may decrease the repetition factor in response to determining that channel conditions are favourable and/or determining that a block error rate is less than a threshold. As another example, network node 115 may increase the repetition factor in response to determining that channel conditions are not favourable and/or that a block error rate is greater than a threshold.

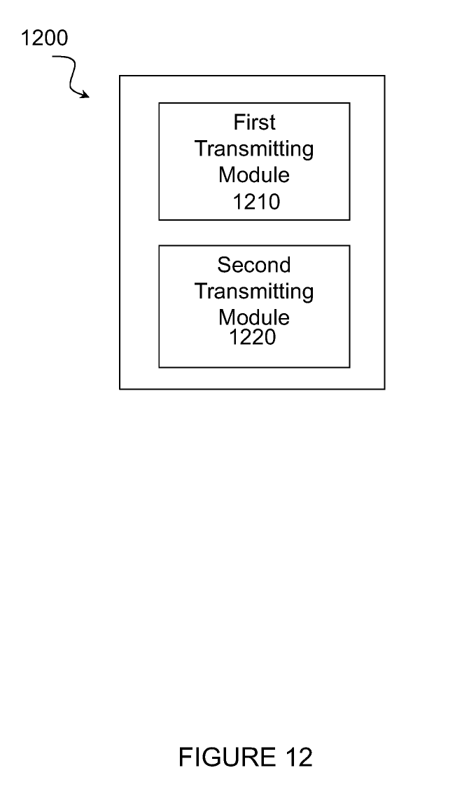

In certain embodiments, the method for providing reliable communication for short TTI through repetitions as described above in FIG. 11 may be performed by a virtual computing device. FIG. 12 illustrates an example virtual computing device 1200 for providing reliable communication for short TTI through repetitions, according to certain embodiments. In certain embodiments, virtual computing device 1200 may include modules for performing steps similar to those described above with regard to the method illustrated and described in FIG. 11. For example, virtual computing device 1200 may include a first transmitting module 1210, a second transmitting module 1220, and any other suitable modules for providing reliable communication for short TTI through repetitions. In some embodiments, one or more of the modules may be implemented using one or more processors such as processor 1020 discussed above with respect 20 FIG. 10. In certain embodiments, the functions of two or more of the various modules may be combined into a single module.

The first transmitting module 1210 may perform certain of the transmitting functions of virtual computing device 1200. For example, in a particular embodiment, transmitting module 1210 may transmit, to a wireless device 110, a configuration comprising a short TTI transmission schedule identifying a repetition factor. According to certain embodiments, the repetition factor represents a number of repeated messages to be received from the virtual computing device 1200.

The second transmitting module 1220 may perform certain other of the transmitting functions of virtual computing device 1200. For example, in a particular embodiment, second transmitting module 1220 may transmit, to a wireless device 110,

Other embodiments of virtual computing device 1200 may include additional components beyond those shown in FIG. 12 that may be responsible for providing certain aspects of the network node's functionality, including any of the functionality described above and/or any additional functionality (including any functionality necessary to support the solutions described above). The various different types of network nodes may include components having the same physical hardware but configured (e.g., via programming) to support different radio access technologies, or may represent partly or entirely different physical components.

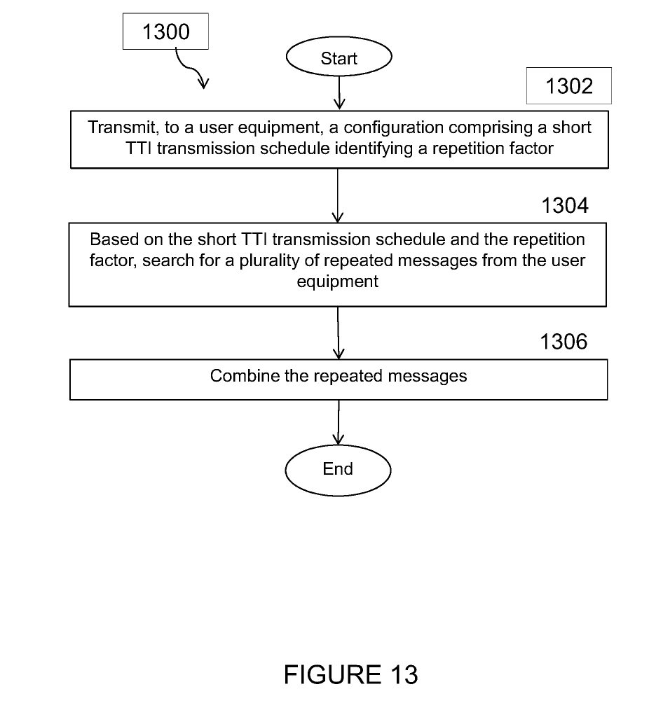

FIG. 13 illustrates an example method 1300 by a network node 110 for providing reliable communication for short TTI through repetitions, according to certain embodiments. The method begins at step 1302 when network node 115 transmits, to a wireless device 110, a configuration comprising a short TTI transmission schedule identifying a repetition factor. According to certain embodiments, the repetition factor represents a number of repeated messages to be transmitted by wireless device 110. In a particular embodiment, the short TTI transmission schedule replaces a sub-1 ms transmission schedule with a 1 ms transmission schedule. In certain embodiments, the configuration may be transmitted in a RRC message or SPS activation message.

In certain embodiments, the configuration identifies a search space. In a particular embodiment, for example, the search space may include one or more ranges of physical resource blocks in which wireless device 110 should transmit repeated messages. In another embodiment, the search space may include a plurality of candidates in each short TTI. In certain embodiments, the configuration may include an index or list of indices or a bitmap of one or more short TTIs containing scheduling information that wireless device 110 may use when transmitting repeated messages. In certain embodiments, the repetition factor represents a number of repeated messages to be transmitted to network node 115 from wireless device 110.

At step 1304, network node 115 searches for a plurality of repeated messages from wireless device 110 based on the short TTI transmission schedule and the repetition factor. According to certain embodiments, the plurality of repeated messages may include control information, data, or a combination of control information and data. In a particular embodiment, for example, the repeated messages comprise control messages, which may include power control commands.

According to certain embodiments, the repeated messages may be received in adjacent short TTIs. The repeated messages may comprise identical repetitions of control and/or data packets. Alternatively, the repeated messages may comprise a plurality of different redundancy versions.

At step 1306, network node 115 combines the repeated messages. In certain embodiments, combining the messages may include selecting candidates for data after all repetitions of the repeated messages are identified. The combined repeated messages may then be decoded.

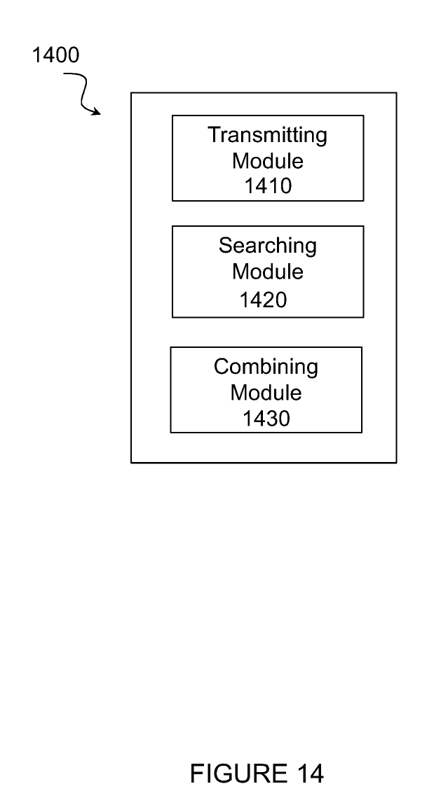

In certain embodiments, the method for providing reliable communication for short TTI through repetitions as described above in FIG. 13 may be performed by a virtual computing device. FIG. 14 illustrates an example virtual computing device 1400 for providing reliable communication for short TTI through repetitions, according to certain embodiments. In certain embodiments, virtual computing device 1400 may include modules for performing steps similar to those described above with regard to the method illustrated and described in FIG. 13. For example, virtual computing device 1400 may include a transmitting module 1410, a searching module 1420, a combining module 1430, and any other suitable modules for providing reliable communication for short TTI through repetitions. In some embodiments, one or more of the modules may be implemented using one or more processors such as processor 1020 discussed above with respect 20 FIG. 10. In certain embodiments, the functions of two or more of the various modules may be combined into a single module.

The transmitting module 1410 may perform the transmitting functions of virtual computing device 1400. For example, in a particular embodiment, transmitting module 1410 may transmit, to a wireless device 110, a configuration comprising a short TTI transmission schedule identifying a repetition factor. According to certain embodiments, the repetition factor represents a number of repeated messages to be transmitted by wireless device 110.

The searching module 1420 may perform the searching functions of virtual computing device 1400. For example, in a particular embodiment, searching module 1420 may search for a plurality of repeated messages from wireless device 110 based on the short TTI transmission schedule and the repetition factor.

The combining module 1430 may perform the combining functions of virtual computing device 1400. For example, in a particular embodiment, combining module 1430 may combine the plurality of repeated messages.

Other embodiments of virtual computing device 1400 may include additional components beyond those shown in FIG. 14 that may be responsible for providing certain aspects of the network node's functionality, including any of the functionality described above and/or any additional functionality (including any functionality necessary to support the solutions described above). The various different types of network nodes may include components having the same physical hardware but configured (e.g., via programming) to support different radio access technologies, or may represent partly or entirely different physical components.

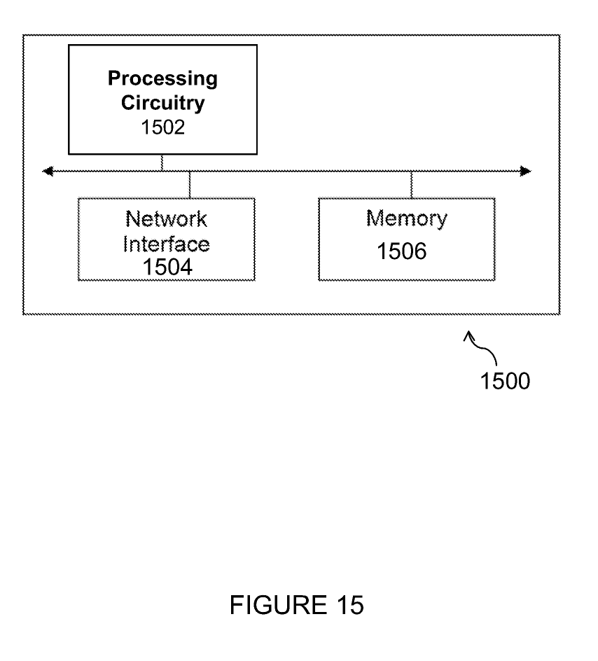

FIG. 15 illustrates an exemplary radio network controller or core network node, in accordance with certain embodiments. Examples of network nodes can include a mobile switching center (MSC), a serving GPRS support node (SGSN), a mobility management entity (MME), a radio network controller (RNC), a base station controller (BSC), and so on. The radio network controller or core network node 1500 include processing circuitry 1520, memory 1530, and network interface 1540. In some embodiments, processing circuitry 1520 executes instructions to provide some or all of the functionality described above as being provided by the network node, memory 1530 stores the instructions executed by processing circuitry 1520, and network interface 1540 communicates signals to any suitable node, such as a gateway, switch, router, Internet, Public Switched Telephone Network (PSTN), network nodes 115, radio network controllers or core network nodes 1500, etc.

Processing circuitry 1520 may include any suitable combination of hardware and software implemented in one or more modules to execute instructions and manipulate data to perform some or all of the described functions of the radio network controller or core network node 1500. In some embodiments, processing circuitry 1520 may include, for example, one or more computers, one or more central processing units (CPUs), one or more microprocessors, one or more applications, and/or other logic.

Memory 1530 is generally operable to store instructions, such as a computer program, software, an application including one or more of logic, rules, algorithms, code, tables, etc. and/or other instructions capable of being executed by a processor. Examples of memory 1530 include computer memory (for example, Random Access Memory (RAM) or Read Only Memory (ROM)), mass storage media (for example, a hard disk), removable storage media (for example, a Compact Disk (CD) or a Digital Video Disk (DVD)), and/or or any other volatile or non-volatile, non-transitory computer-readable and/or computer-executable memory devices that store information.

In some embodiments, network interface 1540 is communicatively coupled to processing circuitry 1520 and may refer to any suitable device operable to receive input for the network node, send output from the network node, perform suitable processing of the input or output or both, communicate to other devices, or any combination of the preceding. Network interface 1540 may include appropriate hardware (e.g., port, modem, network interface card, etc.) and software, including protocol conversion and data processing capabilities, to communicate through a network.

Other embodiments of the network node may include additional components beyond those shown in FIG. 15 that may be responsible for providing certain aspects of the network node's functionality, including any of the functionality described above and/or any additional functionality (including any functionality necessary to support the solution described above).

According to certain embodiments, a method by a first node is provided for reliable communication for short TTI in LTE through repetitions. The first node may include a wireless device in a particular embodiment. The method may include:
receiving, from a second node, a configuration comprising a short TTI transmission schedule identifying a repetition factor; and
based on the short TTI transmission schedule and the repetition factor, searching for a plurality of repeated messages from the second node; and
combining the repeated messages;
optionally, the method further includes selecting candidates for data after all repetitions of the repeated messages are identified;
optionally, the method further includes searching a search space identified by the short TTI transmission schedule for the repeated messages;
optionally, the short TTI transmission schedule replaces a sub-1 ms transmission schedule with a 1 ms transmission schedule;
optionally, the configuration is received in a RRC message;
optionally, the configuration is received in a SPS activation message;
optionally, the method further includes receiving identical repetitions of control and data packets in adjacent short TTIs;
optionally, the method further includes receiving a modified repetition factor that is greater than or less than the repetition factor based on channel conditions;
optionally, the configuration identifies a search space comprising one or more ranges of physical resource blocks;
optionally, the configuration comprises an index or list of indices or a bitmap of one or more short TTIs containing scheduling information;
optionally, the method further includes applying descrambling with a certain identity;
optionally, the repeated messages comprise control messages;
optionally, the control messages comprise power control commands;
optionally, the repetition factor represents a number of different candidates of transmission and the method further includes attempting to decode the number of different candidates of transmission;
optionally, the search space comprises multiple candidates in each short TTI, and wherein the wireless device uses a detected candidate index to find the sequence index of the repetitions;
optionally, the repeated messages comprise a plurality of different redundancy versions;
optionally, the first node comprises a wireless device and the second node comprises a network node; and
optionally, the first node comprises a network node and the second node comprises a wireless device.

According to certain embodiments, a first node is provided for providing reliable communication for short TTI in LTE through repetitions. The first node may be a wireless device, in a particular embodiment, and may include:
a memory comprising instructions;
a processor operable to execute the instructions to cause the processor to:
   receive, from a second node, a configuration comprising a short TTI transmission schedule identifying a repetition factor; and
   based on the short TTI transmission schedule and the repetition factor, search for a plurality of repeated messages from the network node; and
   combine the repeated messages;
optionally, the processor is further operable to select candidates for data after all repetitions of the repeated messages are identified;
optionally, the processor is further operable to search a search space identified by the short TTI transmission schedule for the repeated messages;
optionally, the short TTI transmission schedule replaces a sub-1 ms transmission schedule with a 1 ms transmission schedule;
optionally, the configuration is received in a RRC message;
optionally, the configuration is received in a SPS activation message;
optionally, the processor is further operable to receive identical repetitions of control and data packets in adjacent short TTIs;
optionally, the processor is further operable to receive a modified repetition factor that is greater than or less than the repetition factor based on channel conditions;
optionally, the configuration identifies a search space comprising one or more ranges of physical resource blocks;
optionally, the configuration comprises an index or list of indices or a bitmap of one or more short TTIs containing scheduling information;
optionally, the processor is further operable to apply descrambling with a certain identity;
optionally, the repeated messages comprise control messages;
optionally, the control messages comprise power control commands;
optionally, the repetition factor represents a number of different candidates of transmission and the method further includes attempting to decode the number of different candidates of transmission;
optionally, the search space comprises multiple candidates in each short TTI, and wherein the wireless device uses a detected candidate index to find the sequence index of the repetitions;
optionally, the repeated control messages comprise a plurality of different redundancy versions;
optionally, the first node comprises a wireless device and the second node comprises a network node; and
optionally, the first node comprises a network node and the second node comprises a wireless device.

According to certain embodiments, a method by a first node is provided for reliable communication for short TTI in LTE through repetitions. The first node may be a network node, in a particular embodiment. The method may include:
transmitting, to a second node, a configuration comprising a short TTI transmission schedule identifying a repetition factor; and
based on the short TTI transmission schedule and the repetition factor, transmitting a plurality of repeated messages for combination by the second node;
optionally, the short TTI transmission schedule replaces a sub-1 ms transmission schedule with a 1 ms transmission schedule;
optionally, the configuration is transmitted in a RRC message;
optionally, the configuration is transmitted in a SPS activation message;
optionally, the method further includes transmitting identical repetitions of control and data packets in adjacent short TTIs;
optionally, the method further includes transmitting a modified repetition factor that is greater than or less than the repetition factor based on channel conditions;
optionally, the configuration identifies a search space comprising one or more ranges of physical resource blocks;
optionally, the configuration comprises an index or list of indices or a bitmap of one or more short TTIs containing scheduling information;
optionally, the repeated messages comprise control messages;
optionally, the control messages comprise power control commands;
optionally, the repetition factor represents a number of different candidates of transmission for decoding by the second node;
optionally, the search space comprises multiple candidates in each short TTI, and wherein the wireless device uses a detected candidate index to find the sequence index of the repetitions;
optionally, the repeated messages comprise a plurality of different redundancy versions;
optionally, the first node comprises a network node and the second node comprises a wireless device;
optionally, the first node comprises a wireless device and the second node comprises a network node;

According to certain embodiments, a first node is provided for reliable communication for short TTI in LTE through repetitions. The first node may be a network node, in a particular embodiment, and may include:
a memory comprising instructions;
a processor operable to execute the instructions to cause the processor to:
   transmit, to a second node, a configuration comprising a short TTI transmission schedule identifying a repetition factor; and
   based on the short TTI transmission schedule and the repetition factor, transmit a plurality of repeated messages for combination by the second node
optionally, the short TTI transmission schedule replaces a sub-1 ms transmission schedule with a 1 ms transmission schedule;
optionally, the configuration is transmitted in a RRC message;
optionally, the configuration is transmitted in a SPS activation message;
optionally, the processor is further operable to transmit identical repetitions of control and data packets in adjacent short TTIs;
optionally, the processor is further operable to transmit a modified repetition factor that is greater than or less than the repetition factor based on channel conditions;
optionally, the configuration identifies a search space comprising one or more ranges of physical resource blocks;
optionally, the configuration comprises an index or list of indices or a bitmap of one or more short TTIs containing scheduling information;
optionally, the repeated messages comprise control messages;
optionally, the control messages comprise power control commands;
optionally, the repetition factor represents a number of different candidates of transmission for decoding by the second node;
optionally, the search space comprises multiple candidates in each short TTI, and wherein the wireless device uses a detected candidate index to find the sequence index of the repetitions;
optionally, the repeated messages comprise a plurality of different redundancy versions;
optionally, the first node comprises a network node and the second node comprises a wireless device; and
optionally, the first node comprises a wireless device and the second node comprises a network node.

Certain embodiments of the present disclosure may provide one or more technical advantages. For example, certain embodiments may enable transmissions with very high reliability within a time span less than a subframe. Another advantage may be that ten framework of short transmission time interval (TTI) can be reused and scheduling can therefore be done together with other short TTI users.

Modifications, additions, or omissions may be made to the systems and apparatuses described herein without departing from the scope of the disclosure. The components of the systems and apparatuses may be integrated or separated. Moreover, the operations of the systems and apparatuses may be performed by more, fewer, or other components. Additionally, operations of the systems and apparatuses may be performed using any suitable logic comprising software, hardware, and/or other logic. As used in this document, “each” refers to each member of a set or each member of a subset of a set.

Modifications, additions, or omissions may be made to the methods described herein without departing from the scope of the disclosure. The methods may include more, fewer, or other steps. Additionally, steps may be performed in any suitable order.

Although this disclosure has been described in terms of certain embodiments, alterations and permutations of the embodiments will be apparent to those skilled in the art. Accordingly, the above description of the embodiments does not constrain this disclosure. Other changes, substitutions, and alterations are possible without departing from the spirit and scope of this disclosure, as defined by the following claims.

Abbreviations used in the preceding description include:
BLER Block Error Rate
CQI Channel Quality Indicator
DCI Downlink Control Information
ePDCCH enhanced Physical Downlink Control Channel
LTE Long Term Evolution
MAC Medium Access Control
MCS Modulation and Coding Scheme
OFDM Orthogonal Frequency Division Multiple Access
PDCCH Physical Downlink Control Channel
PDSCH Physical Downlink Shared Channel
PRB Physical Resource Block
PUSCH Physical Uplink Shared Channel
RAT Radio Access Technology
RB Resource Block
RE Resource Element
RRC Radio Resource Control
SC-FDMA Single Carrier-Frequency Division Multiple Access
sPDCCH short Physical Downlink Control Channel
sPDSCH short Physical Downlink Shared Channel
sPUSCH short Physical Uplink Shared Channel
SF SubFrame
TTI Transmission Time Interval

1.-107. (canceled)

108. A method by first node for providing reliable communication for short transmission time interval (TTI) through repetitions, the method comprising:
obtaining a configuration comprising a short TTI transmission schedule identifying a repetition factor;
based on the short TTI transmission schedule and the repetition factor, searching for a plurality of repeated messages from a second node; and
combining the plurality of repeated messages.

109. The method of claim 108, wherein searching for the plurality of repeated messages from the second node comprises:
searching a search space identified by the short TTI transmission schedule for the plurality of repeated messages.

110. The method of claim 109, wherein:
the search space comprises at least one range of physical resource blocks and searching the search space comprises searching the at least one range of physical resource blocks, or
the search space comprises a plurality of candidates in each short TTI and the method further comprises using an index to find the plurality of repeated messages within the plurality of candidates.

111. The method of claim 108, wherein the configuration comprises an index or list of indices or a bitmap of one or more short TTIs containing scheduling information.

112. The method of claim 108, wherein the plurality of repeated messages are received in adjacent short TTIs.

113. The method of claim 108, wherein the repetition factor represents a number of repeated messages received from the second node.

114. The method of claim 108, further comprising modifying the repetition factor by:
in response to determining that channel conditions are favourable, decreasing the repetition factor;
in response to determining that channel conditions are not favourable, increasing the repetition factor;
in response to determining that a block error rate is greater than a threshold, decreasing the repetition factor; or
in response to determining that a block error rate is less than a threshold, increasing the repetition factor.

115. The method of claim 108, wherein the plurality of repeated messages are identical.

116. The method of claim 108, wherein the plurality of messages comprise a plurality of different redundancy versions.

117. The method of claim 108, wherein:
the first node comprises a wireless device and the second node comprises a network node; and
obtaining the configuration comprises receiving, by the wireless device, the configuration from the network node.

118. The method of claim 108, wherein:
the first node comprises a network node and the second node comprises a wireless device; and
the method further includes transmitting, by the network node, the configuration to the wireless device.

119. A first node for providing reliable communication for short transmission time interval (TTI) through repetitions, the first node comprising:
memory storing instructions; and
processing circuitry configured to execute the instructions to cause the first node to:
obtain a configuration comprising a short TTI transmission schedule identifying a repetition factor;
based on the short TTI transmission schedule and the repetition factor, search for a plurality of repeated messages from a second node; and
combine the plurality of repeated messages.

120. The first node of claim 119, wherein searching for the plurality of repeated messages from the second node comprises:
searching a search space identified by the short TTI transmission schedule for the plurality of repeated messages.

121. The first node of claim 120, wherein:
the search space comprises at least one range of physical resource blocks and searching the search space comprises searching the at least one range of physical resource blocks, or
the search space comprises a plurality of candidates in each short TTI, and the method further comprises using an index to find the plurality of repeated messages within the plurality of candidates.

122. The first node of claim 119, wherein the configuration comprises an index or list of indices or a bitmap of one or more short TTIs containing scheduling information.

123. The first node of claim 119, wherein:
the first node comprises a wireless device and the second node comprises a network node; and
the configuration is received by the wireless device from the network node.

124. The first node of claim 119, wherein:
the first node comprises a network node and the second node comprises a wireless device; and
the processing circuitry is further configured to execute the instructions to cause the first node to transmit the configuration to the wireless device.

125. A method by a first node for providing reliable communication for short TTI through repetitions, the method comprising:
obtaining a configuration comprising a short TTI transmission schedule identifying a repetition factor; and
based on the short TTI transmission schedule and the repetition factor, transmitting, to a second node, a plurality of repeated messages for combination by the second node.

126. The method of claim 125, wherein the configuration identifies a search space for searching by the second node for the plurality of repeated messages, the search space comprising:
at least one range of physical resource blocks, or
a plurality of candidates in each sTTI.

127. The method of claim 125, wherein the configuration comprises an index or list of indices or a bitmap of one or more sTTIs containing scheduling information.

128. The method of claim 125, wherein the plurality of repeated messages are transmitted in adjacent sTTIs.

129. The method of claim 125, wherein the repetition factor represents a number of repeated messages transmitted to the second node.

130. The method of claim 125, further comprising modifying the repetition factor by:
in response to determining that channel conditions are favourable, decreasing the repetition factor;
in response to determining that channel conditions are not favourable, increasing the repetition factor;
in response to determining that a block error rate is greater than a threshold, decreasing the repetition factor; or
in response to determining that a block error rate is less than a threshold, increasing the repetition factor.

131. The method of claim 125, wherein:
the first node comprises a wireless device and the second node comprises a network node; and
obtaining the configuration comprises receiving, by the wireless device, the configuration from the network node.

132. The method of claim 125, wherein:
the first node comprises a network node and the second node comprises a wireless device; and
the method further comprises transmitting, by the network node, the configuration to the wireless device.

133. A first node for providing reliable communication for short TTI through repetitions, the first node comprising:
memory storing instructions; and
processing circuitry configured to execute the instructions to cause the first node to:
obtain a configuration comprising a short TTI transmission schedule identifying a repetition factor; and
based on the short TTI transmission schedule and the repetition factor, transmit, to a second node, a plurality of repeated messages for combination by the second node.

134. The first node of claim 133, wherein the configuration identifies a search space for searching by the second node for the plurality of repeated messages, the search space comprising:
at least one range of physical resource blocks, or
a plurality of candidates in each sTTI.

135. The first node of claim 133, wherein the configuration comprises an index or list of indices or a bitmap of one or more sTTIs containing scheduling information.

136. The first node of claim 133, wherein the plurality of repeated messages are transmitted in adjacent sTTIs.

137. The first node of claim 133, wherein:
the first node comprises a wireless device and the second node comprises a network node; and
the configuration is received by the wireless device from the network node.

138. The first node of claim 133, wherein:
the first node comprises a network node and the second node comprises a wireless device; and
the processing circuitry is further configured to transmit the configuration to the wireless device.
